(19) United States
(12) Patent Application Publication
(10) Pub. No.: US 2016/0174348 A1
(43) Pub. Date: Jun. 16, 2016

(54) DEVICE AND METHOD FOR LIGHTING HIGH-PRESSURE DISCHARGE LAMP

(71) Applicant: Phoenix Electric Co., Ltd., Himeji-shi (JP)

(72) Inventors: Tetsuya GOUDA, Himeji-shi (JP); Shinichi USHIJIMA, Himeji-shi (JP)

(21) Appl. No.: 14/829,022

(22) Filed: Aug. 18, 2015

(30) Foreign Application Priority Data
Dec. 11, 2014 (JP) 2014-251132

(51) Int. Cl. H05B 41/30; H05B 41/36

(52) U.S. Cl. CPC H05B 41/30; H05B 41/36

(57) ABSTRACT

A lighting device for a high-pressure discharge lamp comprises a power supply circuit configured to supply an alternating current to the high-pressure discharge lamp so as to light the high-pressure discharge lamp, and to increase a power to be supplied to the high-pressure discharge lamp and reduce a frequency of the alternating current when an inter-electrode voltage of the high-pressure discharge lamp reaches a predetermined inter-electrode voltage lower limit.

### CROSS REFERENCE TO RELATED APPLICATION

This application claims the priority of Japanese Patent Application No. 2014-251132 filed on Dec. 11, 2014, which is incorporated by reference herein.

### BACKGROUND OF THE INVENTION

1. Field of the Invention

The present invention relates to a device and a method for lighting a high-pressure discharge lamp, which are intended to keep lighting the high-pressure discharge lamp in a condition that inter-electrode distance is kept approximately constant.

2. Background Art

A high-pressure discharge lamp is characterized in that quite a large amount of light is obtainable from a single high-pressure discharge lamp. Therefore, the high-pressure discharge lamp has been widely used for a projector and so forth. In the high-pressure discharge lamp, a pair of electrodes made of tungsten is mounted in an internal space of a luminous tube part made of silica glass, and also, mercury is encapsulated in the internal space. When voltage is applied to the pair of electrodes, an arc discharge is generated. Accordingly, evaporated mercury is excited and emits light.

In principle, the high-pressure discharge lamp is kept lit by a constant power control. The value of voltage to be applied to the high-pressure discharge lamp mainly depends on the inter-electrode distance. Accordingly, the value of current to be supplied to the high-pressure discharge lamp depends on the value of voltage depending on the inter-electrode distance. The value of current as described above is determined by an electrical ballast (a stable power supply device). The ballast is configured to provide the high-pressure discharge lamp with current required thereto.

Incidentally, when the high-pressure discharge lamp is kept lit at a constant power, the temperatures of the electrodes disposed therein are regulated in accordance with a set power. When the temperatures of the electrodes are relatively low, there is a tendency that tungsten is accumulated on the surfaces of the electrodes and thereby the inter-electrode distance gradually decreases. Contrarily when the temperatures of the electrodes are relatively high, there is a tendency that the electrodes are reduced in thickness and thereby the inter-electrode distance gradually increases.

When the inter-electrode distance gradually decreases, the value of voltage (inter-electrode voltage) of the high-pressure discharge lamp gradually decreases. Hence, the value of current to be supplied to the high-pressure discharge lamp from the ballast gradually increases. Therefore, when the inter-electrode distance decreases and thereby the value of inter-electrode voltage becomes excessively small, the value of current to be supplied to the high-pressure discharge lamp becomes large, and put differently, a load acting on the ballast becomes large. When the load acting on the ballast becomes large, there is a possibility that the temperature of the ballast highly increases. This has been a drawback of the high-pressure discharge lamp.

To cope with the aforementioned drawback, for instance, Japan Laid-open Patent Application Publication No. JP-A-2002-15883 discloses a technology of obtaining electrodes with a desired shape by arbitrarily selecting the frequency of voltage or alternating current to be applied to a high-pressure discharge lamp.

However, it has been difficult to keep the inter-electrode distance appropriate for a long period of time only by arbitrarily selecting the frequency of voltage or alternating current to be applied to the high-pressure discharge lamp.

The present invention has been developed in view of the aforementioned drawback of the well-known art. Therefore, it is a main object of the present invention to provide a device and a method for lighting a high-pressure discharge lamp, whereby inter-electrode distance can be kept appropriate for a long period of time.

### SUMMARY OF THE INVENTION

According to an aspect of the present invention, provided is a lighting device for a high-pressure discharge lamp with a pair of electrodes, which is configured to supply an alternating current to the high-pressure discharge lamp so as to light the high-pressure discharge lamp, and wherein the lighting device is configured to increase a power to be supplied to the high-pressure discharge lamp when an inter-electrode voltage of the high-pressure discharge lamp reaches a predetermined inter-electrode voltage lower limit.

On the other hand, according to another aspect of the present invention, provided is a lighting device for a high-pressure discharge lamp with a pair of electrodes, which is configured to supply an alternating current to the high-pressure discharge lamp so as to light the high-pressure discharge lamp, and wherein the lighting device is configured to increase a power to be supplied to the high-pressure discharge lamp and reduce a frequency of the alternating current when an inter-electrode voltage of the high-pressure discharge lamp reaches a predetermined inter-electrode voltage lower limit.

The lighting device is preferably configured to reduce a frequency of the alternating current after the power is increased and then a predetermined period of time elapses.

Additionally, in normal lighting, the lighting device is preferably configured to supply the alternating current with a waveform including a base part and a plurality of pulse parts superimposed on the base part. In increasing the power, the lighting device is preferably configured to supply another alternating current with a rectangular waveform.

Alternatively, in normal lighting, the lighting device is preferably configured to supply the alternating current with a waveform in which a polarity is switched a plurality of times in each half cycle. In increasing the power, the lighting device is preferably configured to supply another alternating current with a rectangular waveform.

Then again, according to yet another aspect of the present invention, provided is a method for lighting a high-pressure discharge lamp with a pair of electrodes by supplying an alternating current to the high-pressure discharge lamp, and wherein a power to be supplied to the high-pressure discharge lamp is configured to be increased when an inter-electrode voltage of the high-pressure discharge lamp reaches a predetermined inter-electrode voltage lower limit.

According to the present invention, the value of power to be supplied to the high-pressure discharge lamp is configured to be increased when the inter-electrode voltage of the high-pressure discharge lamp becomes smaller than a predetermined value, put differently, when an inter-electrode distance becomes shorter than a predetermined length. With increase in value of power, the electrodes within the high-pressure discharge lamp increase in temperature and the tips of the electrodes melt. Accordingly, the inter-electrode distance is elongated again, and also, the inter-electrode voltage is restored to a predetermined value. Based on the above, the inter-electrode distance can be kept appropriate for a long period of time.

### BRIEF DESCRIPTION OF THE DRAWINGS

Referring now to the attached drawings which form a part of this original disclosure:

FIG. 1 is a diagram for explaining an exemplary general high-pressure discharge lamp;

FIG. 2 is a diagram for explaining an exemplary lighting device according to the present practical examples;

FIG. 3 is a chart showing an exemplary normal current waveform according to a first practical example;

FIG. 4 includes charts, each showing an exemplary change in value of inter-electrode voltage of the high-pressure discharge lamp;

FIG. 5 is a chart showing an exemplary current waveform in voltage reduction according to the first practical example;

FIG. 6 is a chart showing another exemplary current waveform in voltage reduction according to the first practical example;

FIG. 7 is a chart showing yet another exemplary current waveform in voltage reduction according to the first practical example;

FIG. 8 is a chart showing an exemplary normal current waveform according to a second practical example;

FIG. 9 is a chart showing an exemplary current waveform in voltage reduction according to the second practical example;

FIG. 10 is a chart showing another exemplary current waveform in voltage reduction according to the second practical example; and

FIG. 11 includes charts, each showing an exemplary current waveform in frequency reduction.

### DETAILED DESCRIPTION OF EMBODIMENTS

Explanation will be hereinafter provided for practical examples regarding a high-pressure discharge lamp 10 to which the present invention is applied and a lighting device 100 for lighting the high-pressure discharge lamp 10. (Explanation of High-pressure Discharge Lamp 10)

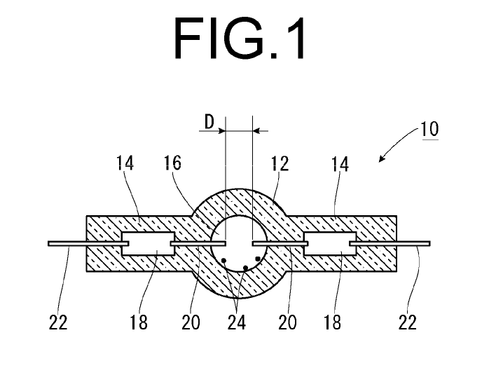

First, the high-pressure discharge lamp 10 will be explained. As shown in FIG. 1, the high-pressure discharge lamp 10 includes a luminous tube part 12 and a pair of sealed parts 14 extending from the luminous tube part 12. The luminous tube part 12 and the sealed parts 14 are integrally made of silica glass. An internal space 16 is formed in the luminous tube part 12, and is sealed by the sealed parts 14. Additionally, foils 18 made of molybdenum are respectively embedded in the sealed parts 14.

Moreover, the high-pressure discharge lamp 10 is provided with a pair of electrodes 20 made of tungsten and a pair of lead rods 22. One end of each electrode 20 is connected to one end of each foil 18, whereas the other end thereof is disposed inside the internal space 16. One end of each lead rod 22 is connected to the other end of each foil 18, whereas the other end thereof extends to the outside from each sealed part 14. Additionally, a predetermined amount of mercury 24 and a predetermined amount of halogen (e.g., bromine) are encapsulated in the internal space 16.

When predetermined high voltage is applied to the pair of lead rods 22 mounted to the high-pressure discharge lamp 10, a glow discharge starts between the pair of the electrodes 20 disposed in the internal space 16 of the luminous tube part 12. Afterwards, the glow discharge transitions to an arc discharge. The mercury 24 is evaporated/excited by the arc and emits light.

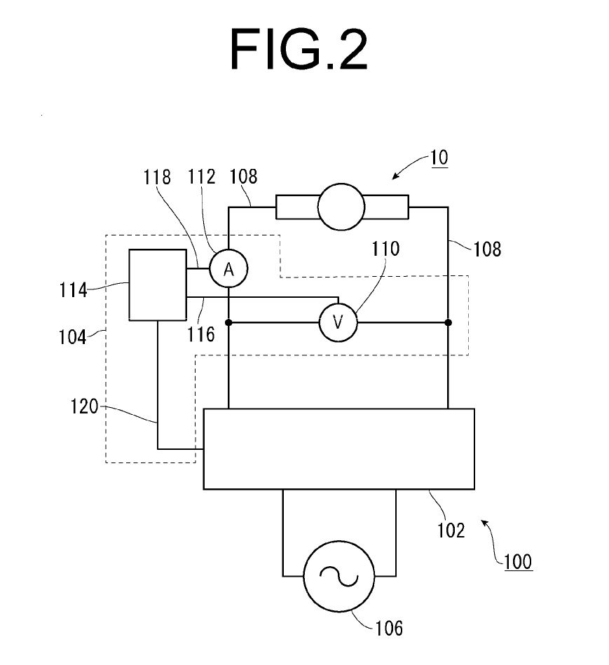

As shown in FIG. 2, the lighting device 100 is mainly composed of a power supply circuit 102 and lighting status transmission means 104.

The power supply circuit 102 is a circuit configured to convert electricity received from a power source 106 into alternating voltage and current suitable for lighting the high-pressure discharge lamp 10 and then supply the alternating voltage and current to the high-pressure discharge lamp 10 through a pair of leads 108. The method for lighting the high-pressure discharge lamp 10 by the power supply circuit 102 will be described in detail.

The lighting status transmission means 104 has a role of checking the lighting status of the high-pressure discharge lamp 10 produced by the power supply circuit 102 on a real-time basis and of feeding back the check result to the power supply circuit 102. In the present practical example, the lighting status transmission means 104 is mainly composed of a voltmeter 110, an ammeter 112 and a transmission circuit 114. The voltmeter 110 is mounted between the pair of leads 108, the ammeter 112 is mounted to either of the leads 108, and the transmission circuit 114 is configured to receive a voltage value V measured by the voltmeter 110 and a current value A measured by the ammeter 112 and then transmit these values to the power supply circuit 102. It should be noted that the transmission circuit 114 and the voltmeter 110 are communicated through a voltage value transmission line 116, the transmission circuit 114 and the ammeter 112 are communicated through a current value transmission line 118, and furthermore, the transmission circuit 114 and the power supply circuit 102 are communicated through a transmission line 120. (Explanation of Current Waveform in First Practical Example)

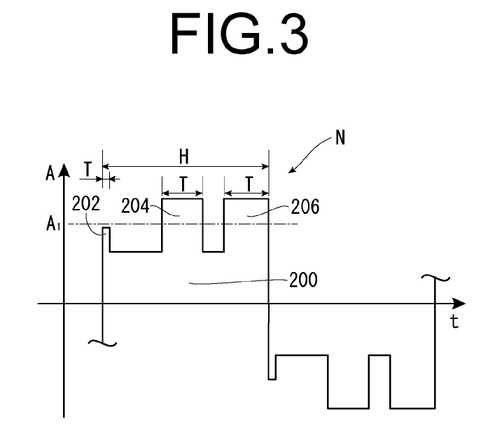

Next, alternating current to be supplied from the aforementioned lighting device 100 to the high-pressure discharge lamp 10 will be explained. As shown in FIG. 3, in a first practical example, the waveform of current (normal current waveform N) to be supplied to the high-pressure discharge lamp 10 has a base part 200 and a plurality of pulse parts 202, 204 and 206 superimposed on the base part 200 in its half cycle H. It should be noted that in normal lighting with the normal current waveform N, lighting power is set to fall in a range of 120-400W and lighting frequency is set to fall in a range of 60-240 Hz. The reason that the lighting power is herein set to fall in a range of 120-400W is as follows: in consideration of the brightness required at present for the high-pressure discharge lamp 10 installed in a projector, the power of the high-pressure discharge lamp 10 is required in a range of 120-400W. Additionally, the lighting frequency of the high-pressure discharge lamp 10 is set to fall in a range of 60-240 Hz on the basis of the relation of synchronization between video signal frequency and lamp lighting frequency in the projector.

In the normal current waveform N according to the present practical example, the three pulse parts 202, 204 and 206 are superimposed on the base part 200 in a single half cycle H. The first pulse part 202 is located in the beginning of the half cycle H. On the other hand, the third pulse part 206 is located in the end of the half cycle H. Additionally, the second pulse part 204 is located between the first pulse part 202 and the third pulse part 206. Moreover, the current value A and a duration T in the second pulse part 204 are roughly the same as those in the third pulse part 206. Furthermore, the current value A and the duration T in the first pulse part 202 are respectively set to be smaller and shorter than those in the second pulse part 204 and those in the third pulse part 206. It should be noted that in FIG. 3, A₁ indicates the average of the current value A in the half cycle H. Additionally, the number of pulse parts to be superimposed in the half cycle H, the duration T of each pulse part, the position of each pulse part, and so forth are not limited to those in the present practical example.

Additionally, in a half cycle next to the half cycle H illustrated in FIG. 3, the current waveform is formed by reversing the polarity of the current waveform in the half cycle H with respect to a line where the current value A is zero. Thus, the polarity of the normal current waveform N of the first practical example is reversed every half cycle.

As shown in the normal current waveform N of the present practical example, one pulse part 202 is superimposed on the base part 200 in the former half of the half cycle H, and furthermore, two pulse parts 204 and 206 are superimposed on the base part 200 in the latter half of the half cycle H. Accordingly, variation in inter-electrode distance can be reduced in the beginning of usage of the high-pressure discharge lamp 10, and thus, remarkable reduction in luminance maintenance factor can be avoided.

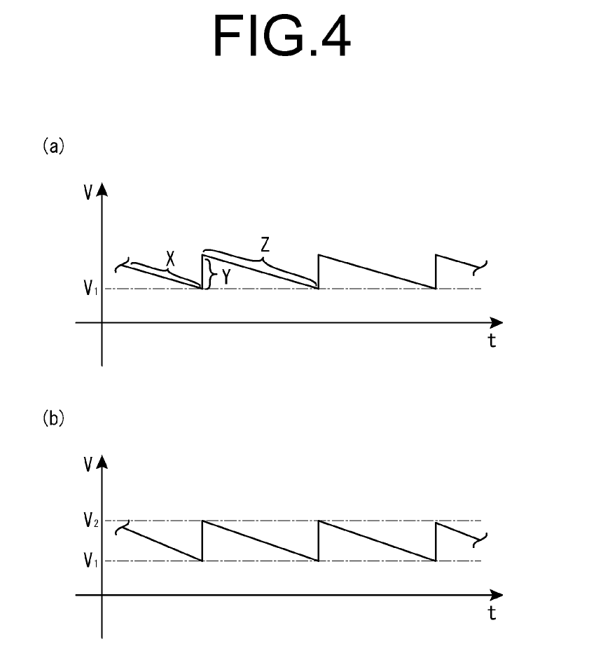

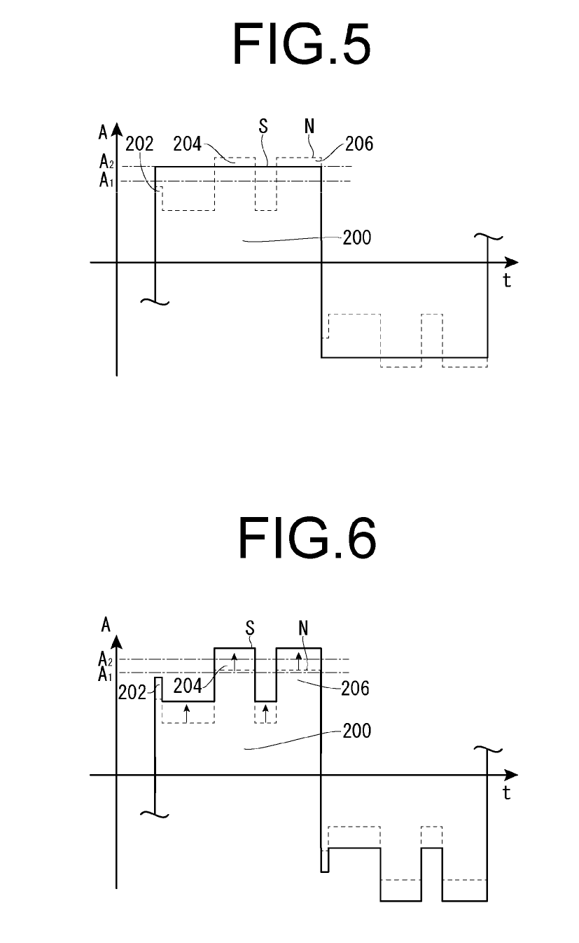

When the high-pressure discharge lamp 10 is continuously lit with the normal current waveform N of the present practical example, an inter-electrode distance D of the high-pressure discharge lamp 10 gradually decreases and an inter-electrode voltage V of the high-pressure discharge lamp 10 gradually decreases as shown in a part X of FIG. 4(a). Then, when the fact that the inter-electrode voltage V has reached a preliminarily set inter-electrode voltage lower limit V₁ is transmitted from the voltmeter 110 of the lighting status transmission means 104 to the power supply circuit 102 through the voltage value transmission line 116, the transmission circuit 114 and the transmission line 120, the power supply circuit 102 is configured to increase a power W (electric power value) to be supplied to the high-pressure discharge lamp 10. Put differently, as shown in FIG. 5, the power supply circuit 102 is configured to produce a rectangular waveform in which the current value A is roughly constant at a current value A₂ higher than the average current value A₁ in the normal current waveform N for the half cycle H as the waveform of current (current waveform S in voltage reduction) to be supplied to the high-pressure discharge lamp 10.

By thus increasing the power W to be supplied to the high-pressure discharge lamp 10, the temperature of each electrode 20 in the high-pressure discharge lamp 10 increases and the tip of each electrode 20 melts. Accordingly, the inter-electrode distance D is elongated again, and as shown in a part Y of FIG. 4(a), the inter-electrode voltage V is also restored to a predetermined value.

When a predetermined period of time elapses after increasing of the power W to be supplied to the high-pressure discharge lamp 10, the power supply circuit 102 is configured to restore the waveform of current to be supplied to the high-pressure discharge lamp 10 back to the normal current waveform N. Accordingly, the inter-electrode distance D again gradually and gently decreases with time, and the inter-electrode voltage V gradually decreases (a part Z of FIG. 4(a)). An action similar to the above will be repeated thereafter. The current waveform may be restored from the current waveform S in voltage reduction to the normal current waveform N after the predetermined period of time elapses as described above or when the inter-electrode voltage V reaches a preliminarily set inter-electrode voltage upper limit V₂ as shown in FIG. 4(b). (Modification of Current Waveform in First Practical Example)

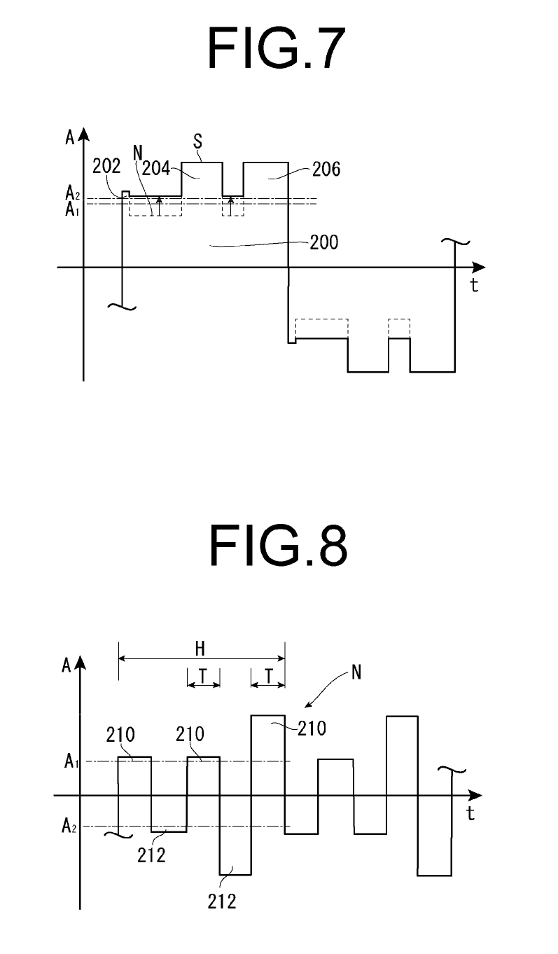

The current waveform S, produced by increasing the power W to be supplied to the high-pressure discharge lamp 10 in the current waveform N of the first practical example, is not limited to the above. For example, as shown in FIG. 6, it can be assumed to produce the current waveform S by increasing the current value A in the respective parts 200, 202, 204 and 206 without changing the ratio in the current value A between the base part 200 and the pulse parts 202, 204 and 206. Alternatively as shown in FIG. 7, the current waveform S may be produced by increasing the current value A of the base part 200 without changing the heights (the peaks of the current value A) in the respective pulse parts 202, 204 and 206. In the configuration, the current value A increases in the parts among the respective pulse parts 202, 204 and 206, and accordingly, the power W increases as a whole in the half cycle H (i.e., the average current value increases to A₂). (Explanation of Current Waveform in Second Practical Example)

As shown in FIG. 8, in the second practical example, the polarity of the normal current waveform N to be supplied to the high-pressure discharge lamp 10 is configured to be switched a plurality of times in each half cycle H. Put differently, in the second practical example, the current waveform has a plurality of positive periods 210 and a plurality of negative periods 212 in each half cycle H. The current value A is positive in the positive periods 210, whereas the current value A is negative in the negative periods 212. It should be noted that in a half cycle next to the half cycle H illustrated in FIG. 8, the current waveform is shaped by reversing the polarity of the current waveform (i.e., the positive periods 210 and the negative periods 212) in the half cycle H with respect to a line where the current value A is zero. Additionally in FIG. 8, A₁ indicates the average of the current value A in the positive periods 210 of the half cycle H, whereas A₂ indicates the average of the current value A in the negative periods 212 of the half cycle H. Thus, in the second practical example, the current waveform N has the positive periods 210 and the negative periods 212 as described above, and hence, the average current value A₁ exists in the positive range whereas the average current value A₂ exists in the negative range.

With the current waveform N as shown in the second practical example, it is possible to light the high-pressure discharge lamp 10 suitable for a video display system utilizing, for instance, DLP (Digital Light Processing). For example, a color wheel is used for DLP. The color wheel is divided into red, blue and green sectors and is configured to be rotated at a high speed. Desired colors can be herein projected by associating the positive periods 210 and the negative periods 212 of the current waveform N in the second practical example with the respective color sectors of the color wheel.

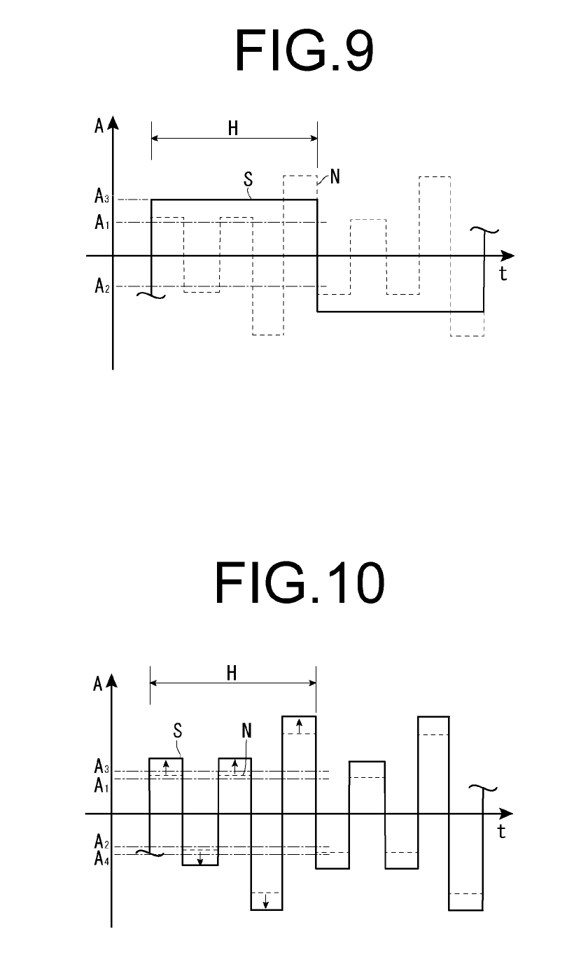

When the high-pressure discharge lamp 10 is continuously lit with the normal current waveform N in the present practical example, the inter-electrode distance D of the high-pressure discharge lamp 10 gradually decreases and the inter-electrode voltage V of the high-pressure discharge lamp 10 gradually decreases as shown in the part X of FIG. 4(a). Then, when the fact that the inter-electrode voltage V has reached the preliminarily set inter-electrode voltage lower limit V₁ is transmitted from the voltmeter 110 of the lighting status transmission means 104 to the power supply circuit 102 through the voltage value transmission line 116, the transmission circuit 114 and the transmission line 120, the power supply circuit 102 is configured to increase the power W to be supplied to the high-pressure discharge lamp 10. Put differently, as shown in FIG. 9, the power supply circuit 102 is configured to produce a rectangular waveform in which the current value A is roughly constant at a current value A₃ higher than the average current values A₁ and A₂ for the half cycle H as the waveform of current (the current waveform S in voltage reduction) to be supplied to the high-pressure discharge lamp 10. In short, the polarity is not switched every period in each half cycle H.

By thus increasing the power W to be supplied to the high-pressure discharge lamp 10, the temperature of each electrode 20 in the high-pressure discharge lamp 10 increases and the tip of each electrode 20 melts. Accordingly, the inter-electrode distance D is elongated again, and as shown in the part Y of FIG. 4(a), the inter-electrode voltage V is also restored to the predetermined value.

When a predetermined period of time elapses after increasing of the power W to be supplied to the high-pressure discharge lamp 10, the power supply circuit 102 is configured to restore the waveform of current to be supplied to the high-pressure discharge lamp 10 back to the normal current waveform N. Accordingly, the inter-electrode distance D again gradually and gently decreases with time, and the inter-electrode voltage V gradually decreases (the part Z of FIG. 4(a)). An action similar to the above will be repeated thereafter. The current waveform may be restored from the current waveform S in voltage reduction to the normal current waveform N after the predetermined period of time elapses as described above or when the inter-electrode voltage V reaches the preliminarily set inter-electrode voltage upper limit V₂ as shown in FIG. 4(b).

### Modification of Current Waveform in Second Practical Example

The current waveform S, produced by increasing the power W to be supplied to the high-pressure discharge lamp 10 in the current waveform N of the second practical example, is not limited to the above. For example, as shown in FIG. 10, the absolute value of the current value A in the respective positive and negative periods 210 and 212 may be increased. Accordingly, the power W to be supplied to the high-pressure discharge lamp 10 increases as a whole in the half cycle H.

### Reduction in Frequency

In the aforementioned (first and second) practical examples, the power W to be supplied to the high-pressure discharge lamp 10 is configured to be increased when the inter-electrode distance D of the high-pressure discharge lamp 10 gradually decreases and accordingly the inter-electrode voltage V reaches the preliminarily set inter-electrode voltage lower limit V₁. In addition to this, the frequency of current waveform may be reduced. In the aforementioned practical examples, as described above, a rectangular waveform in which the current value A is roughly constant at the current value A₂, A₃ for the half cycle is produced as the current waveform S in voltage reduction. Hence, even when the frequency of current waveform is reduced, it is possible to avoid a situation that light from the high-pressure discharge lamp 10 looks flickering. By contrast, there is a possibility that light from the high-pressure discharge lamp 10 looks flickering when it is assumed to reduce the frequency of the normal current waveform N of the first practical example in which the pulse parts 202, 204 and 206 are superimposed on the base part 200 or reduce the frequency of the normal current waveform N of the second practical example in which the polarity is switched a plurality of times in each half cycle H.

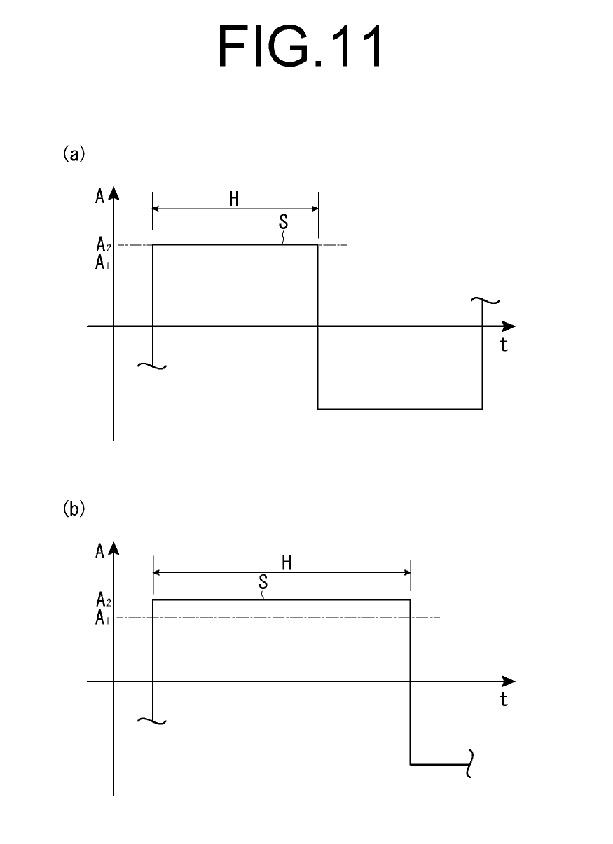

Reduction in frequency of current waveform will be specifically explained with the current waveform N of the first practical example. As shown in FIG. 11, the current waveform S to be supplied to the high-pressure discharge lamp 10 is transformed into a rectangular waveform in which the current value A is A₂ higher than the normal average current value A₁ (FIG. 11(a)). Then, after elapse of a predetermined period of time (e.g., 0.5 seconds), the rectangular current waveform is reduced in frequency (to 20 Hz, for instance) without being transformed (FIG. 11(b)). It should be noted that in consideration of responsiveness to variation in power of the lighting device 100, the predetermined period of time is desirably set so as to reliably complete transformation of the current waveform.

As described above, reduction in frequency of current waveform may be started after the power W to be supplied to the high-pressure discharge lamp 10 is increased and then the predetermined period of time elapses, or may be started at the same timing as increasing of the power W. Additionally, reduction in frequency of current waveform may be performed only for a preliminarily set period of time (e.g., 1-5 seconds). Moreover, as described above, reduction in frequency of current waveform may be continued until the inter-electrode voltage V reaches the predetermined inter-electrode voltage upper limit V₂.

Similarly to the above, reduction in frequency of current waveform will be also performed with use of the current waveform N of the second practical example. The waveform of current to be supplied to the high-pressure discharge lamp 10 is transformed into a rectangular waveform in which the current value A is A₃ higher than the normal average current value A₁, A₂. Then, after elapse of a predetermined period of time (e.g., 0.5 seconds), the rectangular current waveform is reduced in frequency (to 20 Hz, for instance) without being transformed. It should be noted that reduction in frequency of current waveform may be started after the power W to be supplied to the high-pressure discharge lamp 10 is increased and then the predetermined period of time elapses, or may be started at the same timing as increasing of the power W. Additionally, reduction in frequency of current waveform may be performed only for a preliminarily set period of time (e.g., 1-5 seconds), or as described above, may be continued until the inter-electrode voltage V reaches the predetermined inter-electrode voltage upper limit V₂.

The inter-electrode distance D can be more quickly elongated not only by thus increasing the power W to be supplied to the high-pressure discharge lamp 10 but also by reducing the frequency of the rectangular current waveform. Consequently, the current waveform can be quickly restored from the current waveform S in voltage reduction to the normal current waveform N.

It should be noted that it is preferred to define the inter-electrode voltage lower limit V₁ by the following formula:

Inter-electrode voltage lower limit V₁≧Rated power value/Designed current value×0.8

The rated power value is herein defined as a power value in a normal lighting mode. In general, devices (e.g., a projector) using the high-pressure discharge lamp 10 have “normal lighting mode” and “power saving mode” for lighting the high-pressure discharge lamp 10 at a power lower than that required in the normal lighting mode.

Additionally, the designed current value is defined as an average current value in lighting at the rated power value.

Moreover, it is preferred to define a rate of increase in power in increasing the power W by the following formula:

Rate of increase in power=1.36×(Lighting power value/Rated power value)²−2.67×(Lighting power value/Rated power value)+2.31

The lighting power value is herein defined as a power value immediately before increasing the power W during lighting.

When an actual rate of increase in power becomes higher than the rate of increase in power defined by the aforementioned formula, the melting speed of the electrodes 20 becomes too fast, and thus, the inter-electrode voltage V greatly varies after increase in power. Contrarily when the actual rate of increase in power becomes lower than the rate of increase in power defined by the aforementioned formula, the melting speed of the electrodes 20 becomes slow and an effect of melting the electrodes 20 cannot be easily achieved.

Furthermore, it is preferred to define a reduction rate in reducing the frequency of alternating current by the following formula:

Rate of reduction in frequency=(Lighting power value/Rated power value)×30

According to the aforementioned formula, post-reduction frequency becomes lower as the lighting power value becomes lower. Hence, even when the power W is low, the effect of melting the electrodes 20 is not lost.

Although the invention has been described in its preferred form with a certain degree of particularity, it is understood that the present disclosure of the preferred form has been changed in the details of construction and the combination and arrangement of parts may be resorted to without departing from the spirit and scope of the invention as hereinafter claimed.

What is claimed is:

1. A lighting device for a high-pressure discharge lamp, comprising:
a power supply circuit configured to supply an alternating current to the high-pressure discharge lamp so as to light the high-pressure discharge lamp, and to increase a power to be supplied to the high-pressure discharge lamp and reduce a frequency of the alternating current when an inter-electrode voltage of the high-pressure discharge lamp reaches a predetermined inter-electrode voltage lower limit.

2. A lighting device for a high-pressure discharge lamp, comprising:
a power supply circuit configured to supply an alternating current to the high-pressure discharge lamp so as to light the high-pressure discharge lamp, and to increase a power to be supplied to the high-pressure discharge lamp when an inter-electrode voltage of the high-pressure discharge lamp reaches a predetermined inter-electrode voltage lower limit, and to reduce a frequency of the alternating current after the power is increased and then a predetermined period of time elapses.

3. The lighting device according to claim 1, wherein
in normal lighting, the power supply circuit is configured to supply the alternating current with a waveform including a base part and a plurality of pulse parts superimposed on the base part, and
in increasing the power, the power supply circuit is configured to supply another alternating current with a rectangular waveform.

4. The lighting device according to claim 2, wherein
in normal lighting, the power supply circuit is configured to supply the alternating current with a waveform including a base part and a plurality of pulse parts superimposed on the base part, and
in increasing the power, the power supply circuit is configured to supply another alternating current with a rectangular waveform.

5. The lighting device according to claim 1, wherein
in normal lighting, the power supply circuit is configured to supply the alternating current with a waveform in which a polarity is switched a plurality of times in each half cycle, and
in increasing the power, the power supply circuit is configured to supply another alternating current with a rectangular waveform.

6. The lighting device according to claim 2, wherein
in normal lighting, the power supply circuit is configured to supply the alternating current with a waveform in which a polarity is switched a plurality of times in each half cycle, and
in increasing the power, the power supply circuit is configured to supply another alternating current with a rectangular waveform.

7. The lighting device according to claim 3, wherein
the pulse parts have a first pulse part, a second pulse part and a third pulse part,
the first pulse part is located in the beginning of each half cycle,
the third pulse part is located in the end of the half cycle,
the second pulse part is located between the first pulse part and the third pulse part,
the current value in the first pulse part is set to be smaller than that in the second pulse part and that in the third pulse part.

8. The lighting device according to claim 4, wherein
the pulse parts have a first pulse part, a second pulse part and a third pulse part,
the first pulse part is located in the beginning of each half cycle,
the third pulse part is located in the end of the half cycle,
the second pulse part is located between the first pulse part and the third pulse part,
the current value in the first pulse part is set to be smaller than that in the second pulse part and that in the third pulse part.

9. A method for lighting a high-pressure discharge lamp, comprising:
increasing a power of an alternating current to be supplied to the high-pressure discharge lamp and reducing a frequency of the alternating current when an inter-electrode voltage of the high-pressure discharge lamp reaches a predetermined inter-electrode voltage lower limit.
